(19) United States
(12) Patent Application Publication
(10) Pub. No.: US 2004/0052524 A1
(43) Pub. Date: Mar. 18, 2004

(54) Method of power control in an optical communication system

(76) Inventor: Philip Arnold, Brinklow, Rugby (GB)

Correspondence Address: Kirschstein Ottinger Israel & Schiffmiller, 489 Fifth Avenue, New York, NY, 10017-6105, US

(21) Appl. No.: 10/380,296

(22) PCT Filed: Sep. 12, 2001
(86) PCT No.: PCT/GB01/04087

(30) Foreign Application Priority Data
Sep. 13, 2000 (GB) 0022607.6

(51) Int. Cl. H04J 14/02; H04B 10/08

(52) U.S. Cl. 398/38; 398/34; 398/30; 398/157

(57) ABSTRACT

An optical communication system (10) and a method of operating the system (10) to reduce non-linear phenomena in optical fibre waveguides (60, 70) included within the system (10) are discribed. The communication system (10) comprises a plurality of nodes (20, 40) coupled together by optical fibre waveguides (60, 70) for guiding communication traffic bearing radiation between the nodes. The system (10) further comprises: an attenuator and associated optical amplifier (110, 120) for regulating radiation power of the communication bearing radiation at the first node to generate corresponding output radiation; an a coupler (130) for emitting the output radiation into the optical fibre waveguide (60) to propagate to a second node (70). A power monitor (210) is provided for measuring radiation power of the output radiation received at the second node after it has been conveyed through the waveguiding means and for generating corresponding power indicative data. A power controller (160) for receiving the power indicative data is operable to regulate the radiation power measured at the second node to a predetermined level by generating corresponding error data and communication the error data to the attenuator (110) for controlling the attenuator (110) so that the radiation power measured at the second node is stabilized substantially at the predetermined level at which optical non-linearities are reduced to less than a predetermined threshold in the optical fibre waveguide (60).

The present invention concerns a method of power control in an optical communication system; the invention also relates to an optical communication system operating according to the method.

Optical communication systems are known and comprise a number of spatially distributed nodes interconnected through optical fibre waveguides, the waveguides operable to convey information bearing radiation between the nodes. Such systems often employ wavelength division multiplexing (WDM) techniques so that communication traffic propagating between the nodes is modulated onto one or more radiation components occupying corresponding mutually different wavebands. The wavebands are frequently referred to as channels.

When such systems are operating, the number of channels in use can be dynamically changing as WDM add/drop multiplexers and WDM cross-connects at the nodes are reconfigured under software control to add or remove active channels. Dynamic changes can also arise because of channel failures arising from optical parts being disturbed or damaged, for example during maintenance procedures.

The systems are designed to maintain mutually similar radiation power in active channels propagating along wav guides in the systems so that optical devices such as pumped erbium doped fibre amplifiers (EDFAS) incorporated therein are not subjected to sudden input power fluctuations nor to excess radiation concentrated in specific channels. As EDFAs are inherently non-linear devices, disparity in relative channel radiation powers input to such EDFAs can cause accentuation of channel radiation power differences.

It is therefore conventional practice in the nodes of the systems to include feedback loops to monitor and regulate radiation power associated with the channels to ensure that they are of mutually similar power. Moreover, it is also conventional practice when outputting radiation from nodes to emit into associated waveguides as much radiation power as possible and to apply attenuation at nodes subsequently receiving the emitted radiation. This practice is adopted in order to try to obtain as high a signal-to-noise ratio as possible in the systems and hence improve their traffic carrying capacity. Additionally, for design simplicity, it is also conventional practice to include an attenuator at each receiver node to regulate the power of received radiation applied to an optical detector thereat; such design simplicity enables the attenuator, the detector and an associated power control feedback loop to be co-sited at the receiver node.

The inventor has appreciated that the amount of radiation power presently emitted in conventional optical communication systems is sufficient to cause optical non-linear effects in optical fibre waveguides interconnecting nodes. In long-haul optical fibre waveguide paths approaching 100 km in length, such non-linear effects occur primarily in regions of the paths closest to where radiation is launched thereinto on account of attenuation along the waveguide paths reducing the power of the radiation at regions of the paths remote from where the radiation is launched thereinto. Moreover, such non-linear effects can result in four-way mixing, cross phase modulation and similar mutual interactions between radiation components. In some communication systems including long-haul optical fibre waveguide paths approaching 100 on in length without optical repeaters, radiation emitted thereinto can be 100 mW or more. The inventor has further appreciated that the non-linear effects can themselves be bandwidth limiting to the systems. Moreover, when emitted radiation power levels exceed 1 W in a communication system optical fibre waveguide, waveguide reliability can deteriorate because there is sufficient power to physically damage the waveguide in the event of a defect arising in the waveguide; standing wave patterns can arise which causes extensive damage along major parts of waveguides.

The inventor has further appreciated that it is important in future high-performance optical communication systems to control the total power of composite WDM radiation emitted into optical fibre waveguides of the systems; this is a departure from conventional practice where excess received power is controlled using input attenuators. Such control is necessary to reduce interactions arising from waveguide non-linear optical phenomena and to circumvent reliability problems when excess radiation power is emitted into the waveguides. The excess power can severely damage the waveguides in the event of one or more defects occurring therein, for example a waveguide split or localised point of power absorption therein.

According to a first aspect of the present invention, there is provided a method of power control in an optical communication system, the system comprising a plurality of nodes coupled together by optical waveguiding means for guiding communication traffic bearing radiation between the nodes, the method including the steps of: regulating the power of the communication traffic bearing radiation at the first node to provide optical output radiation; emitting the optical output radiation through the waveguiding means to a second node of the system; measuring radiation power of the output radiation received at the second node to generate corresponding power indicative data; communicating the power indicative data to controlling means operable to generate error data for regulating the optical output radiation measured at the second node to a predetermined power level; and communicating the error data to the power regulating means at the first node for controlling the regulating means so that the radiation power of the output radiation received at the second node is stabilized substantially at the predetermined level at which optical non-linearities are reduced to less than a predetermined threshold in the waveguiding means.

The invention provides the advantage that it possible to reduce optical non-linear effects in the waveguiding means by operating the communication system according to the method.

The aforementioned predetermined threshold is defined as a threshold at which system performance, for example bit error rate, is not substantially limited by non-linear optical phenomena arising in the waveguiding means but by other factors in the system, for example polarisation mode dispersion.

Preferably, the method is applied in an optical communication system wherein the communication traffic bearing radiation is wavelength division multiplexed into a plurality of channels.

In the method, it is beneficial that at least one of the power indicative data and the error data are communicated in a supervisory channel associated with the channels bearing the communication traffic. Use of the supervisory channel circumvents a need to provide alternative communication pathways for conveying at least one of the power indicative data and the error data.

In one form of the method, it is preferable that the controlling means is located at the first node. Such an arrangement enables the regulating means and the controlling means to be collocated at the first node with the monitoring means located at the second node, the second node therefore only providing a power monitoring function for the method.

Alternatively, the controlling means can be located at the second node; however, such an arrangement may often require more information to be conveyed between the nodes compared to collocating the regulating means and the controlling means.

Conveniently, the first node includes monitoring means for determining the number of active wavelength division multiplexed channels present in the communication bearing radiation and varying the predetermined level in response to the number of active channels. Varying the predetermined level in response to the number of active channels enables a compromise to be reached between circumventing optical non-linear effects in the waveguiding means and maintaining signal-to-noise ratio.

The predetermined level is preferably varied substantially as a linear function of the number of active channels so that radiation power per active channel is maintained substantially constant at the second node in operation. Alternatively, the predetermined power level is beneficially maintained substantially constant when one or more channels in the output radiation are active; such a substantially constant output power received at the second node ensures that components such as erbium doped fibre amplifiers in both the first and the second nodes are operating at nominally constant power.

Beneficially, the controlling means is operable to set the regulating means to an attenuation greater than −20 dB when none of the channels are active. This attenuation applied when none of the channels are active reduces the amount of optical noise injected into the waveguiding means.

It is also preferable in the method that: the regulating means is operable to attenuate independently radiation of each channel propagating therethrough; and radiation in each channel is monitored individually at the second node so that the controlling means is capable of independently adjusting attenuation of each channel at the first node to substantially equalize radiation power present in the channels which are active.

Such independent control of the channels enables the system to perform channel leveling for output radiation received at the second node, thereby correcting for differential frequency-dependent attenuation phenomena occurring in the waveguiding means.

In order to simplify the system, it is preferable in the method that the regulating means is provided by an optical amplifier whose forward gain is controllable by the error data modulating optical pumping power applied to the amplifier.

In a second aspect of the present invention, there is provided an optical communication system comprising a plurality of nodes coupled together by optical waveguiding means for guiding communication traffic bearing radiation between the nodes, the system further comprising: power regulating means for regulating radiation power of the communication traffic bearing radiation at the first node to generate corresponding output radiation; emitting means at the first node for emitting the output radiation into the waveguiding means for propagation to a second node of the system; radiation power measuring means for measuring radiation power of the output radiation received at the second node after it has been conveyed through the waveguiding means and for generating corresponding power indicative data; and controlling means for receiving the power indicative data and using it to regulate the radiation power measured at the second node to a predetermined level by generating corresponding error data and communicating the error data to th regulating means for controlling the regulating means so that the radiation power measured at the second node is stabilized substantially at the predetermined level at which optical non-linearities are reduced to less than a predetermined threshold in the waveguiding means.

Conveniently, the communication bearing radiation is wavelength division multiplexed into a plurality of channels. Such wavelength division multiplexing provides the system with a potentially relatively large communication traffic communicating capability. Moreover, use of wavelength division multiplexing enables the system to provide the communication bearing radiation with a supervisory channel for communicating at least one of the error data and the power indicative data between the first and second nodes. Such a supervisory channel circumvents a need to include alternative communication pathways for conveying supervisory information within the system.

Preferably, the controlling means is co-located with the regulating means at the first node. The co-location enables the error data to be communicated within the first node. Alternatively, the controlling means can be located at the second node so that the measuring means and the controlling means are co-located for communicating the power indicative data within the second node.

Advantageously, the first node includes monitoring means for determining the number of active wavelength division multiplexed channels present in the communication bearing radiation and varying the predetermined level in response to the number of active channels. Varying the predetermined level in response to the number of active channels enables the system to improve signal-to-noise ratio whilst circumventing effects due to optical non-linearity in the waveguiding means.

The controlling means is preferably operable to vary the predetermined level substantially as a linear function of the number of active channels so that the radiation power per active channel remains substantially constant in operation. Such a constant level of radiation power per active channel ensures that the signal-to-noise ratio of each active channel is maintained as the number of active channels is varied. Alternatively, the controlling means is beneficially operable to maintain the predetermined power level substantially constant at the second node when one or more channels in the output radiation are active; the substantially constant predetermined power level ensures that devices such as optical amplifiers in the nodes can operate at nominally constant pumping power.

Preferably, the controlling means is operable to set the regulating means to an attenuation greater than −20 dB when none of the channels are active. This attenuation reduces optical noise being injected into the waveguiding means when none of the channels are active, and thereby reduces bit error rate occurrence within the system.

In order to compensate for frequency-dependent optical attenuation phenomena in the waveguiding means, the regulating means is preferably operable to independently regulate radiation power of radiation associated with each channel propagating therethrough, and the monitoring means is operable to monitor radiation power of each channel independently at the second node so that the controlling means is capable of individually adjusting radiation power of each channel at the first node to substantially mutually equalize radiation power of the channels which are active. Beneficially, the active channels are mutually equalized in radiation power to within 6 dB.

Embodiments of the invention will now be described, by way of example only, with reference to the following diagrams in which:

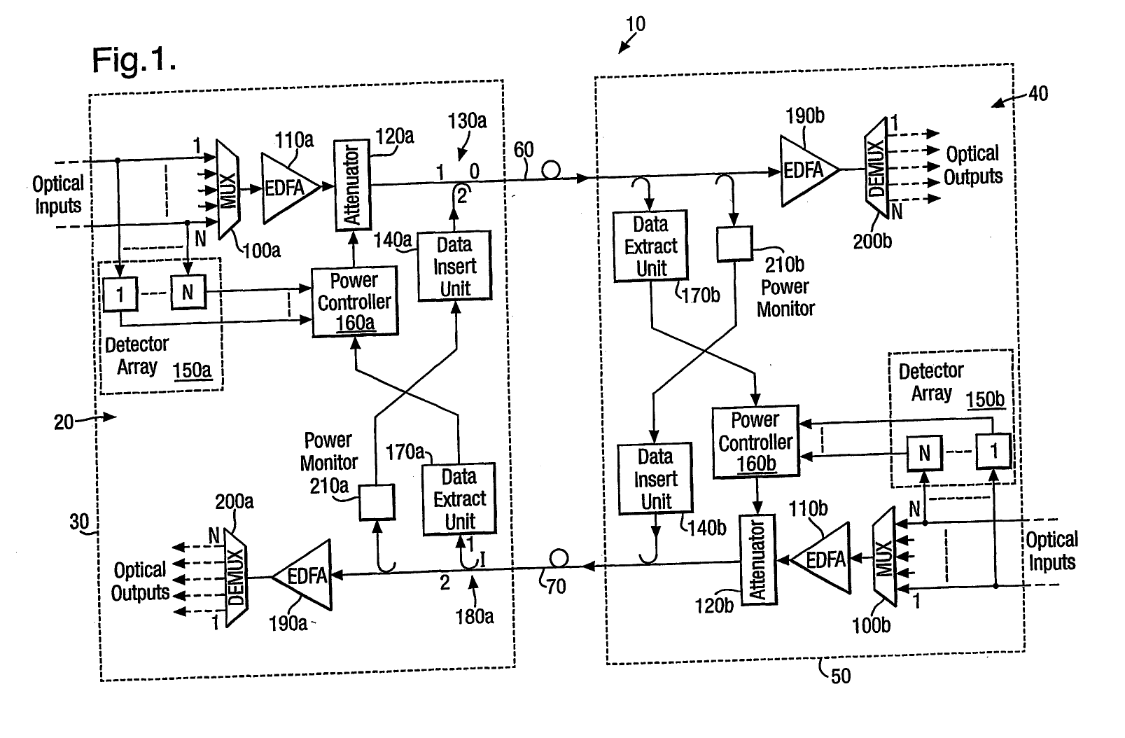

FIG. 1 is a schematic illustration of a first embodiment of the invention, the embodiment comprising two optical communication system nodes mutually interconnected through associated optical fibre waveguides; and

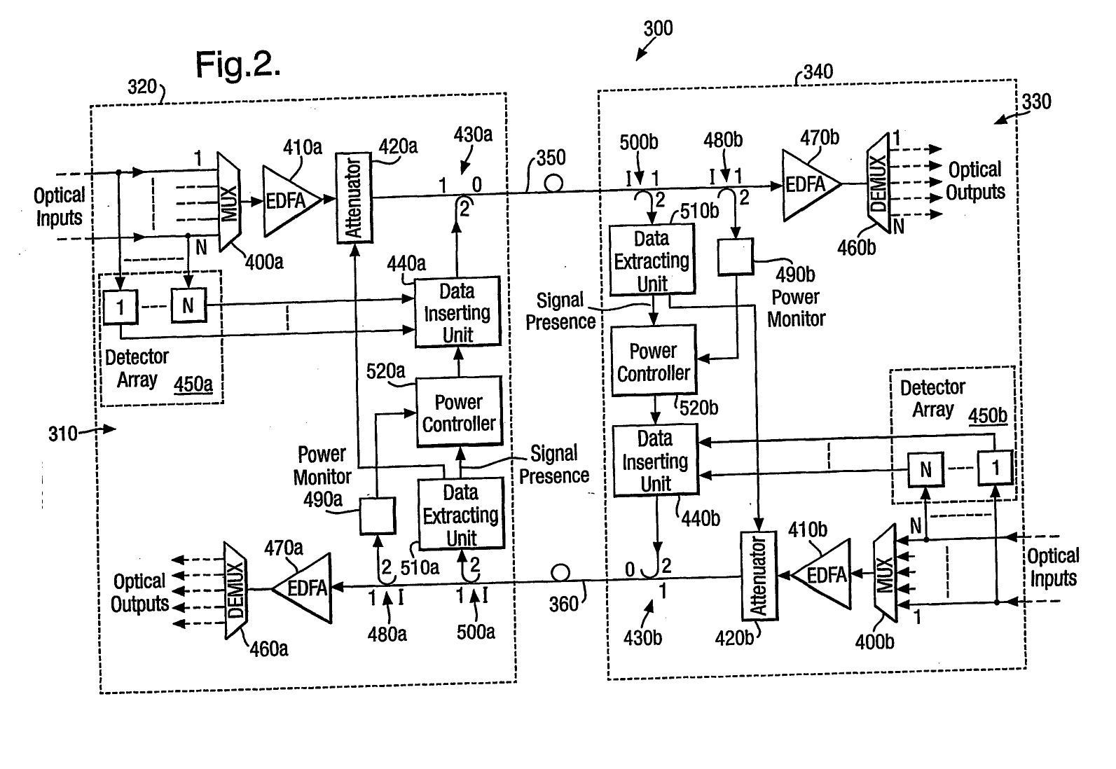

FIG. 2 is a schematic illustration of a second embodiment of the invention, the embodiment comprising two optical communication system nodes mutually interconnected through associated optical fibre waveguides.

Referring to FIG. 1, there is shown a part of an optical communication system 10 comprising first and second nodes 20, 40 respectively. The first node 20 is included within a dotted line 30 and the second node 40 is included within a dotted line 50. The first node 20 is connected to the second node 40 through an optical fibre waveguide 60 for conveying communication traffic from the first node 20 to the second node 40. Likewise, the second node 40 is connected to the first node 20 through an optical fibre waveguide 70 for conveying traffic from the second node 40 to the first node 20. The nodes 20, 40 include identical components for communicating to one another.

Communication between the nodes 20, 40 will now be described in general overview.

The first node 20 receives up to N optical input radiation signals and multiplexes them to provide first composite radiation. The first node 20 then amplifies the first composite radiation, and subsequently attenuates the resulting amplified first composite radiation and finally adds a first monitoring signal thereto to provide first output radiation for emitting into the waveguide 60 to the second node 40. The first node 20 also receives second output radiation from the second node 40, extracts a second monitoring signal therefrom, amplifies the second output radiation and then demultiplexes the amplified second radiation to provide up to N optical output signals. The node 20 employs the second monitoring signal to regulate attenuation of the first composite radiation so as to provide a predetermined first output radiation received power level at the second node 40. Such regulation also takes account of attenuation occurring in the waveguide 60.

Likewise, in a reciprocal manner, the second node 40 receives up to N optical input radiation signals and multiplexes them to provide second composite radiation. The second node 40 then amplifies the second composite radiation, and subsequently attenuates the resulting amplified second composite radiation and finally adds the second monitoring signal thereto to provide the second output radiation for emitting into the waveguide 70 to the first node 20. The second node 40 also receives the first output radiation from the first node 20, extracts the first monitoring signal therefrom, amplifies the first output radiation and then demultiplexes the amplified first output radiation to provide up to N optical output signals. The node 40 employs the first monitoring signal to regulate attenuation of the second composite radiation to provide a predetermined second radiation received power at the first node 20. Such regulation also compensates for attenuation occurring along the waveguide 70.

The first node 20 monitors power in the second output radiation received thereat to generate the first monitoring signal. Similarly, the second node 40 monitors power in the first output radiation received thereat to generate the second monitoring signal. Thus, the first node 20 monitors the second output radiation it receives from the second node 40 and provides feedback to the second node 40 for it to regulate its attenuator so that the second radiation is maintained at a predetermined power level as monitored by the first node 20. Likewise, in a reciprocal manner, the second node 40 monitors the first output radiation it receives from the first node 20 and provides feedback to the first node 20 for it to regulate its attenuator so that the first radiation is also maintained at a predetermined power level as monitored by the second node 40. As a consequence of regulating the output radiation in the nodes 20, 40 to a regime where optical non-linear phenomena in the waveguides 60, 70 are substantially circumvented, performance of the system 10 is thereby enhanced.

Component parts of the nodes 20, 40 will now be described in further detail. The nodes 20, 40 are configured in an identical manner and include similar component parts; on account of the similarity, only component parts of the first node 20 will be elucidated. Component parts of the first node 20 will be identified by a qualifier ‘a’ whereas corresponding component parts of the second node 40 will be identified by a qualifier ‘b’.

The first node 20 comprises an optical multiplexer 100a including N optical input ports for receiving up to N input radiation signals. The multiplexer 100a comprises an optical output port which is conveyed through an erbium doped fibre amplifier (EDFA) 110a and then through an attenuator 120a to a first optical input port of a coupler 130a. A second optical input port of the coupler 130a is connected to an optical output port of a supervisory channel data inserting unit 140a. An optical output port of the coupler 130a is connected to the fibre waveguide 60 for coupling the first output radiation from the coupler 130a to the second node 40. The N input ports are also connected to corresponding optical input ports of an array of power detectors 150a whose power monitoring electrical outputs are conveyed to a power controller 160a. An electrical output of the controller 160a is connected to an electrical control input of the attenuator 120a for controlling attenuation provided by the attenuator 120a. A further electrical input to the controller 160a is connected to an electrical output of a supervisory channel data extracting unit 170a whose optical input is connected to a first optical output port of a coupler 180a. A second optical output port of the coupler 180a is coupled through an EDFA 190a to an optical input port of an optical demultiplexer 200a. The demultiplexer 200a includes N optical output ports at which up to N radiation signals are output in operation. The second optical output port of the coupler 180a is also conveyed to an optical input of a power monitor 210a The power monitor 210a includes an electrical output which is connected to an electrical input of the data inserting unit 140a. An optical input port of the coupler 180a is coupled to the fibre waveguide 70.

Radiation conveyed along the fibre waveguides 60, 70 is in WDM form where the N radiation signals are included in mutually different wavelength ranges, each signal occupying a range of wavelengths corresponding to its associated channel. Moreover, the radiation in the waveguides 60, 70 also includes radiation corresponding to one or more supervisory channels, the supervisory channels being used to convey, amongst other supervisory information, radiation power data for use in controlling the attenuator 120a. The supervisory channels are set at wavelength ranges different to those associated with the N radiation signals. If necessary, the supervisory channels can occupy a wavelength range corresponding to a channel N+1, namely following monotonically from channels 1 to N used to convey communication traffic.

Operation of the first node 20 will now be described in detail with reference to FIG. 1.

The second node 40 operates in a similar reciprocal manner. The first node 20 receives input radiation from the node 40 via the fibre waveguide 70. The radiation propagates to the coupler 180a whereat it is split into first and second components, the first component passing to the data extracting unit 170a and the second component coupling to the power monitor 210a and also via the EDFA 190a to the demultiplexer 200a. Radiation received at the demultiplexer 200a is filtered and directed to respective optical outputs depending upon radiation wavelength The power monitor 210a measures total power in radiation output from the second port of the coupler 180a to provide corresponding power data which it passes to the data insertion unit 140a. The unit 140a inserts the power data into the supervisory channel present in radiation output from the first node 20 along the fibre waveguide 60 to the second node 40; the second node 40 thereby establishes total radiation power received at the first node 20 and its power controller 160b compares the total radiation power with a predetermined power level and proceeds to generate an error signal for adjusting its attenuator 120b to stabilize the total power measured at the first node 20 at the predetermined power level. The first component of radiation from the coupler 180a passes to the data extraction unit 170a which extracts therefrom supervisory information supplied from the second node 40 relating to total power in radiation receive thereat from the first node 20 as measured by the power monitor 210b. Total power information passes from the extraction unit 170a to the power controller 160a which also receives radiation power information from the array 150a; power information from the array 150a is used by the power controller 160a to set an appropriate attenuation for the attenuator 120a, for example depending upon the number of optical inputs of the multiplexer 100a receiving radiation and thereby being active. The power controller 160a forms part of a feedback loop and generates an error signal for adjusting attenuation provided by the attenuator 120a to maintain the total power in radiation received at the second node 40 to a predetermined power level. In a first operating regime, the predetermined power level can be maintained constant irrespective of the number of active channels provided that at least one channel is active. Alternatively, in a second operating regime, the predetermined power level can be made variable as a linear function of the number of active inputs to the multiplexer 100a in order to maintain radiation power per active channel substantially constant, for example within a 6 dB error margin.

It is preferable that up to N input radiation signals received at the nodes 20, 40 are mutually equalised in power prior to being input to the multiplexers 100a, 100b; such equalisation is necessary to circumvent the EDFAs 10a, 110b accentuating radiation of certain relatively more powerful channels. If necessary, optical power leveling units can be included in the nodes 20, 40 and configured to precede the multiplexers 100a, 100b.

In a modified version of the nodes 20, 40, the EDFAs 110a, 110b can be modified to provide a variable amplification function, thereby circumventing a need to include the attenuators 120a, 120b and hence simplifying the nodes 20, 40; gain provided by the EDFAs 110a, 110b can, for example, be controlled from the power controllers 160a, 160b by adjusting pumping power applied to the EDFAs 110a, 110b. Moreover, the EDFAs 190a, 190b can be omitted to provide a further simplification of the nodes 20, 40 provided that sufficient radiation power is received for the demultiplexers 200a, 200b to output sufficient radiation power at their optical output ports.

A power control feedback loop provided in part by the power controller 160a in the node 20 is arranged to have a relatively long time constant, for example greater than one second. Such a relatively long time constant is chosen to try to avoid transient overshoot in the feedback loop from occurring. Most changes in radiation power received at the nodes 20, 40 from one another arise, other than by deliberately inserting and removing channels, as a result of environmental temperature changes which occur gradually, for example over a time period of minutes. Thus, the nodes 20, 40 are effective at compensating for varying power losses occurring along the fibre waveguides 60, 70 as well as fluctuations in optical gain provided by the EDFAs 110a, 110b.

As described earlier, in a first operating regime, the nodes 20, 40 are normally operated to maintain received radiation power at a predetermined power limit. Alternatively, in a second operating regime, the aforementioned predetermined level can be made variable for each of the nodes 20, 40 depending upon the number of active channels being conveyed between the nodes 20, 40; the power controllers 160a, 160b are capable of determining the number of active channels from power information received thereat from the detector arrays 150a, 150b respectively. If there are no active inputs conveying input radiation to the multiplexers 100a, 100b, their respective power controllers 160a, 160b can be operable to apply a relatively high attenuation, for example in the order of −35 dB and at least greater than −20 dB, at their associated attenuators 120a, 120b to prevent the attenuators 120a, 120b being set to minimum attenuation and thereby injecting optical noise into the fibre waveguides 60, 70. The first regime ensures that the EDFAs 110a, 110b are operating a nominally constant power output. The second regime ensures that radiation associated with each WDM channel conveyed through the fibre waveguides 60, 70 is of nominally constant power.

The present invention is capable of being implemented in alternative embodiments to that shown in FIG. 1. Referring now to FIG. 2, there is shown part of a communication system indicated by 300, the part 300 comprising first and second nodes. The first node is indicated by 310 and is included within a dotted line 320. Similarly, the second node is indicated by 330 and is included within a dotted line 340. The first node 310 is connected to the second node 330 through an optical fibre waveguide 350 for conveying communication traffic from the first node 310 to the second node 330. Likewise, the second node 330 is connected to the first node 310 through an optical fibre waveguide 360.

Component parts included in the nodes 310, 330 for use in mutually communicating along the fibre waveguides 350, 360 are identical and similarly configured. These parts will now be described using a qualifier ‘a’ to refer to a component in the first node 310 and a qualifier ‘b’ to refer to a component in the second node 330.

The component parts and their interconnection will now be elucidated for the first node 310, Similar component parts and interconnection pertain to the second node 330. The first node 310 includes an optical multiplexer 400a comprising N optical input ports for receiving up to N input radiation signals and an optical output connected through an EDFA 410a to an optical input port of an optical attenuator 420a. An optical output port of the attenuator 420a is coupled to a first input port of an optical coupler 430a. The coupler 430a comprises a second input port which is coupled to an optical output port of a data inserting unit 440a. As well as being connected to the multiplexer 440a, the N input ports are also conveyed to an optical detector array 450a, each port having its corresponding detector in the array 450a. Electrical measurement outputs from the array 450a are coupled to electrical inputs of the supervisory channel inserting unit 440a.

The first node 310 further includes an optical demultiplexer 460a comprising N optical output ports and an optical input port coupled to an optical output port of an EDFA 470a. The EDFA 470a incorporates an optical input port which is connected to a first output port of an optical coupler indicated by 480a. A second output port of the coupler 480a is coupled to an optical input port of a power monitor 490a. An input port of the coupler 480a is connected to a first output port of an optical coupler 500a. A second output port of the coupler 500a is coupled to an optical input port of a data extracting unit 510a. Lastly, an input port of the coupler 500a is connected to the fibre waveguide 360.

The first node 310 additionally comprises a power controller 520a which is connected to receive power monitoring output data from the power monitor 490a and also a signal presence output from the data extraction unit 510a An electrical output from the power controller 520a is coupled to an electrical input of the data inserting unit 440a. Finally the data extracting unit 510a includes a first signal presence output which is connected to an electrical input of the power controller, and also includes a second output which is coupled to a control input of the attenuator 420a.

Operation of the nodes 310, 330 will now be elucidated in general overview.

The first node 310 receives up to N optical radiation signals at the multiplexer 400a and multiplexes them to provide first composite radiation which is subsequently amplified by the EDFA 410a. The amplified composite radiation propagates to the attenuator 420a which controllably attenuates it to provide corresponding first output radiation which passes through the coupler 430a to the fibre waveguide 350. The first output radiation propagates to the second node 330 and is received at the coupler 500b thereof. The coupler 500b diverts a portion of the radiation received thereat to the data extracting unit 510b and another portion via the coupler 480b to the power monitor 490b and to the EDFA 470b. The EDFA 470b amplifies radiation received thereat from the coupler 480b and outputs corresponding amplified radiation to the demultiplexer 460b. The demultiplexer 460b filters radiation received thereat from the EDFA 470b and thereby separates out radiation components according to their wavelength to associated N optical outputs.

Radiation received at the node 330 via the fibre waveguide 350 is diverted through the coupler 480b to the power monitor 490b which measures power received thereat and generates corresponding power indicative data. The power indicative data is subsequently passed to the power controller 520b. The power controller 520b functions as part of a feedback loop for controlling attenuation provided by the attenuator 420a to stabilize radiation power as measured by the power monitor 490b at a predetermined level. The power controller 520b outputs error data for adjusting attenuation provided by the attenuator 420a, the error data passing to the supervisory channel data inserting unit 440b which inserts the error data into a supervisory channel associated with second output radiation emitted from the second node 330 into the fibre waveguide 360. The second radiation propagates to the first node 310 and a portion of the radiation is coupled through the coupler 500a to the supervisory channel data extracting unit 510a which isolates the error data generated in the power controller 520b and passes it to the control input of the attenuator 420a.

The detector array 450a monitors radiation power in the radiation signals input to the multiplexer 400a and passes corresponding radiation power indicative data to the data inserting unit 440a which outputs the power indicative data in appropriate digital format onto the first output radiation which propagates to the second node 330, for example via the supervisory channel. The power indicative data is used in the nodes 310, 330 to determine which of the N inputs to the multiplexer 400a are active. The power indicative data is retrieved at the second node 330 by the data extracting unit 510b; the data is conveyed to the power controller 520b for use therein for calculating appropriate error data for determining attenuation to be provided by the attenuator 420a for achieving a predetermined radiation power level as monitored by the power monitor 490b.

In a similar manner to the nodes 20, 40, in a first operating regime, the predetermined power level can be maintained by the power controllers 520a, 520b at a constant level, irrespective of the number of active inputs to the multiplexers 400a, 400b. Alternatively, in a second operating regime, the predetermined power level can be varied as a linear function of the number of active inputs as determined by the detector arrays 450a, 450b. The first regime ensures that the EDFAs 410a, 410b are operating at nominally constant power, whereas the second regime ensures that radiation power per WDM channel conveyed through the fibre waveguides 350, 360 is nominally constant. When none of the input ports to the multiplexers 400a, 400b are active, their associated power controllers 520b, 520a respectively can set their associated attenuators 420a, 420b to provide a relatively high attenuation, for example in the order of −35 dB and at least greater than −20 dB, such high attenuation preventing the attenuators 420a, 420b otherwise being set by their feedback loops to provide minimum attenuation resulting in significant optical noise being injected into the fibre waveguides 350, 360. Such optical noise can, for example, result in an increase in system communication traffic bit error rate.

It will be appreciated from the foregoing that in both the nodes 20, 40 as well as the nodes 310, 330 power control is achieved by stabilising received radiation power by way of feedback loops and omitting input attenuators to ensure that only a requisite amount of radiation power is output to the waveguides 60, 70, 350, 360, thereby keeping to a minimum optical non-linearities arising in the waveguides. There arises a threshold level of radiation power below which system performance does not improve as the radiation power output to the waveguides 60, 70, 350, 360 is reduced; other factors, for example polarisation mode dispersion or chromatic dispersion, at the threshold level begin to dominate system performance. In comparison, it is conventional practice to emit as much power as possible into waveguides and then to dissipate excess power at locations of radiation reception; such an approach results in greater fibre waveguide non-linearities arising than necessary.

It will also be appreciated by one skilled in the art that modifications can be made to the nodes 20, 40, 310, 330 without departing from the scope of the invention. For example, one or more of the attenuators 120a, 120b, 420a, 420b can be a multichannel attenuator allowing independent attenuation adjustment for each WDM channel present in radiation propagating therethrough. In this respect, one or more of the power monitors 210a, 210b, 490a, 490b can be modified to measure radiation power present in each WDM channel received thereat. Such a modification enables the feedback loops provided in the nodes 20, 40, 310, 330 not only to reduce optical non-linearities in the fibre waveguides 60, 70, 350, 360 but also to provide a power leveling function. The power leveling function can be used to substantially mutually equalize power present in the active channels; equalization is defined as corresponding to a mutual power difference of less than 6 dB between the active channels. Such power leveling circumvents power hogging to certain more prominent channels from occurring in the EDFAs 190a, 190b, 470a, 470b. Moreover, the power leveling also compensates for any wavelength dependent attenuation effects which may occur within the fibre waveguides 60, 70, 350, 360.

With regard to N, namely the number of input ports to the multiplexers 100a, 100b, 400a, 400b, and also the number of output ports of the demultiplexers 200a, 200b, 460a, 460b, N is preferably in a range of 8 to 128 to make the nodes 20, 40, 310, 330 compatible with future optical communication systems.

The nodes 20, 40, 310, 330 can form part of an optical communication system wherein the nodes 20, 40, 310, 330 function as cross-connects and add/drop multiplexers.

1. A method of power control in an optical communication system, the system comprising a plurality of nodes coupled together by optical waveguiding means for guiding communication traffic bearing radiation between the nodes, the method including the steps of: regulating the power of the communication traffic bearing radiation at the first node to provide optical output radiation; emitting the optical output radiation through the waveguiding means to a second node of the system; measuring radiation power of the output radiation received at the second node to generate corresponding power indicative data; communicating the power indicative data to controlling means operable to generate error data for regulating the optical output radiation measured at the second node to a predetermined power level; and communicating the error data to the power regulating means at the first node for controlling the regulating means so that the radiation power of the output radiation received at the second node is stabilized substantially at the predetermined level at which optical non-linearities are reduced to less than a predetermined threshold in the waveguiding means.

2. A method according to claim 1 wherein the communication traffic bearing radiation is wavelength division multiplexed into a plurality of channels.

3. A method according to claim 2 wherein at least one of the power indicative data and the error data are communicated in a supervisory channel associated with the channels bearing the communication traffic.

4. A method according to claim 1, 2 or 3 wherein the controlling means is located at the first node.

5. A method according to claim 1, 2 or 3 wherein the controlling means is located at the second node.

6. A method according to any preceding claim wherein the first node includes monitoring means for determining the number of active wavelength division multiplexed channels present in the communication traffic bearing radiation and varying the predetermined level in response to the number of active channels.

7. A method according to claim 6 wherein the predetermined level is varied substantially as a linear function of the number of active channels so that radiation power per active channel is maintained substantially constant at the second node in operation.

8. A method according to any one of claims 1 to 5 wherein the predetermined power level is maintained substantially constant when one or more channels in the output radiation are active.

9. A method according to claim 2 wherein the controlling means is operable to set the regulating means to an attenuation greater than −20 dB when none of the channels are active.

10. A method according to claim 2 wherein: the regulating means is operable to attenuate independently radiation of each channel propagating therethrough; and radiation in each channel is monitored individually at the second node so that the controlling means is capable of independently adjusting attenuation of each channel at the first node to substantially equalize radiation power present in the channels which are active.

11. A method according to any preceding claim wherein the regulating means is provided by an optical amplifier whose forward gain is controllable by the error data modulating optical pumping power applied to the amplifier.

12. An optical communication system (10:300) comprising a plurality of nodes (20,40:310,330) coupled together by optical waveguiding means (60,70:350,360) for guiding communication traffic bearing radiation between the nodes, the system further comprising: power regulating means (120:420) for regulating radiation power of the communication traffic bearing radiation at the first node to generate corresponding output radiation; emitting means at the first node for emitting the output radiation into the waveguiding means for propagation to a second node of the system, radiation power measuring means (210:490) for measuring radiation p wer of the output radiation received at the second node after it has been conveyed through the waveguiding means and for generating corresponding power indicative data; and controlling means (160:520) for receiving the power indicative data and using it to regulate the radiation power measured at the second node to a predetermined level by generating corresponding error data and communicating the error data to the regulating means (120:420) for controlling the regulating means so that the radiation power measured at the second node is stabilized substantially at the predetermined level at which optical non-linearities are reduced to less than a predetermined threshold in the waveguiding means.

13. A system according to claim 12 wherein the communication traffic bearing radiation is wavelength division multiplexed into a plurality of channels.

14. A system according to claim 13 wherein the communication bearing radiation is provided with a supervisory channel for communicating at least one of the error data and the power indicative data between the first and second nodes (20,40:310,330).

15. A system according to claim 12, 13 or 14 wherein the controlling means (160) is located at the first node (20).

16. A system according to claim 12, 13 or 14 wherein the controlling means (520) is located at the second node (330).

17. A system according to any one of claims 12 to 16 wherein the first node includes monitoring means (150:450) for determining the number of active wavelength division multiplexed channels present in the communication traffic bearing radiation and varying the predetermined level in response to the number of active channels.

18. A system according to claim 17 wherein the controlling means (160:520) is operable to vary the predetermined level substantially as a linear function of the number of active channels so that the radiation power per active channel remains substantially constant at the second node in operation.

19. A system according to any one of claims 12 to 16 wherein the controlling means (160:520) is operable to maintain the predetermined power level substantially constant when one or more channels in the output radiation are active.

20. A system according to claim 13 wherein the controlling means (160:520) is operable to set the regulating means (120:420) to an attenuation greater than −20 dB when none of the channels are active.

21. A system according to claim 13 wherein the regulating means (120:420) is operable to independently regulate radiation power of radiation associated with each channel propagating therethrough, and the monitoring means (210:490) is operable to monitor radiation power of each channel independently at the second node so that the controlling means is capable of individually adjusting radiation power of each channel at the first node to substantially mutually equalize radiation power of the channels which are active.

22. A system according to claim 21 wherein the active channels are mutually equalized in radiation power to within 6 dB.
